(19) United States
(12) Patent Application Publication
(10) Pub. No.: US 2008/0106118 A1
(43) Pub. Date: May 8, 2008

(54) Pickup camper loading guides

(76) Inventor: Steve Norman Smeltzer, Spokane Valley, WA (US)

Correspondence Address: STEVE N. SMELTZER, P.O. BOX 333, VERADALE, WA, 99037, US

(21) Appl. No.: 11/592,498

(22) Filed: Nov. 4, 2006

(51) Int. Cl. B60P 3/345

(52) U.S. Cl. 296/164

(57) ABSTRACT

Pickup Camper Loading Guides is a right side and left side alignment device designed to allow a driver to quickly and easily pre-position a pickup truck for loading a camper. The invention consisting of two thin guide rails that are manually extracted from within a case or cavity that defines and runs the length of a camper's lower right side and left side. The extended guide rails create the same dimensions as that of a camper's frame that fits into the bed of a pickup truck thus providing visual alignment instruments for a driver.

### BACKGROUND OF THE INVENTION

This patent relates to pickup truck bed mounted campers. This type of camper is raised and lowered by way of long extendable jacks, which are mounted on all four corners of the camper. When the camper is to be loaded into a pickup truck bed, the jacks are extended and the camper is raised to a height adequate for the pickup truck to be backed under the camper and then lowered into the pickup truck bed.

The process involved in loading this type of camper can be tedious and sometimes take many attempts to properly align a pickup, and then proceed to back under the camper for loading. There is very little room for error given the width of the lower portion of the camper box frame that fits into the pickup bed is nearly the same width as the pickup bed itself. To properly load a camper the backup angle of the pickup truck must be at the same angle as the camper.

During the loading process the driver may be required to exit the vehicle many times to check the pickups positioning or rely on continuous communication and direction adjustments from an individual outside the vehicle. It is imperative that the pickups initial alignment to the camper be correct before attempting to back the pickup under the camper.

The current art seems to be focused more and relates more directly towards aids and devices designed for assisting in proper alignment of towing vehicles to trailers and camper trailers rather than the loaded and hauled types therefore, the applicant cannot cite or reference similar or previous patents in the current art.

The invention, pickup camper loading guides, will take the guess work out of the alignment process saving the individual time and make the loading process less stressful.

The guides are quickly and easily extracted from casings installed on either side of a camper giving the driver a view of the same dimensions that will be needed to properly load the camper. The driver can visually align the guides into the pickup bed and thus have the pick pre-positioned in the proper alignment necessary to accommodate the camper.

### BRIEF SUMMARY OF THE INVENTION

It is an object of the present invention to provide a device which enables a single person to quickly and easily position a pickup truck into proper alignment for loading a pickup mounted camper.

It is further an object of the present invention to provide an alignment device for any type of loading or transport vehicles of pickup mounted campers.

It is further an objective of the present invention to provide an easily installed, inexpensive and durable device beneficial to both experienced and inexperienced individuals for loading all types of pickup mounted campers. Additionally, this simple yet very effective device is intended to save time while reducing the stress and tension that is associated with this tedious procedure.

The objects of this invention will be accomplished by providing a thin pair, right side and left side, of guide rails capable of sliding easily in and out of their individual cases to an indicator line near the opposite end of the rail. The cases provide the means for the guide rails to perform the function of an alignment tool, additionally the guide rails performing the same function from within a similar cavity or case pre-designed in newly constructed campers to house a guide rail instrument.

The objects further accomplished by providing thin rigid guide rails that are manually extended from within a case fastened to a camper to define and impersonate the lower right side and left side of the camper frame. The extracted rails extend out parallel to each other to create the equivalent of the camper frame. The cases and rails themselves are of durable and compatible material so as the rails communicate properly with the cases to achieve the needed tolerances to hold their rigidity while fully extended, yet travel smoothly within the cavity of the case.

The objects further accomplished by providing guide rails for a driver to visually use as an alignment instrument. The rails will visually indicate to the driver if the pickup has achieved proper alignment prior to attempting the final loading process.

Other objects, advantages, features and details of the present invention will be apparent after reading the specifications related to the following drawings.

### BRIEF DESCRIPTION OF THE DRAWINGS

FIG. 1 is a top view of a pickup truck and camper with extended guide rails illustrating a preferred form of the invention.

FIG. 2 is a multi-dimensional view of a camper with extended left side and right side guide rails.

FIG. 3 is a close-up side view with the guide rail component extending slightly out of the case cavity while in the fully retracted position.

FIG. 4 is a close-up side view with the guide rail partially extracted from within the case cavity.

FIG. 5 is a top view with the guide rail and case on edge, and partially extracted from within the case cavity.

FIG. 6 is a multi-dimensional view of one end of the guide rail fully extracted and separate from a case cavity.

### DETAILED DESCRIPTION OF THE INVENTION

Pickup camper loading guides are constructed of smooth durable material such as, but not limited to, nylon or plastics. The guide rails travel in and out of cases which are fastened to previously built campers with little or no alterations to existing construction. A straight and flush installation, along the camper's lower edges, is accomplished with typical flat headed fasteners and typical washers or shims may be used to accommodate any irregularities or existing trim.

The intent and scope of this invention is not intended to be limited to guide rails that extend solely from a case or cavity that is fastened to previously built campers. The same or similar cases or cavities may also be built into newly constructed campers for the purpose of providing a guide rail instrument. Guide rails, as recited in this invention, extent and retract from within a case or a cavity housing providing a loading aid and performing the functions described in this invention. A preferred embodiment of this invention is the extendable guide rails from within a cavity of a pickup mounted camper for the purpose of pickup truck or loading vehicle alignment.

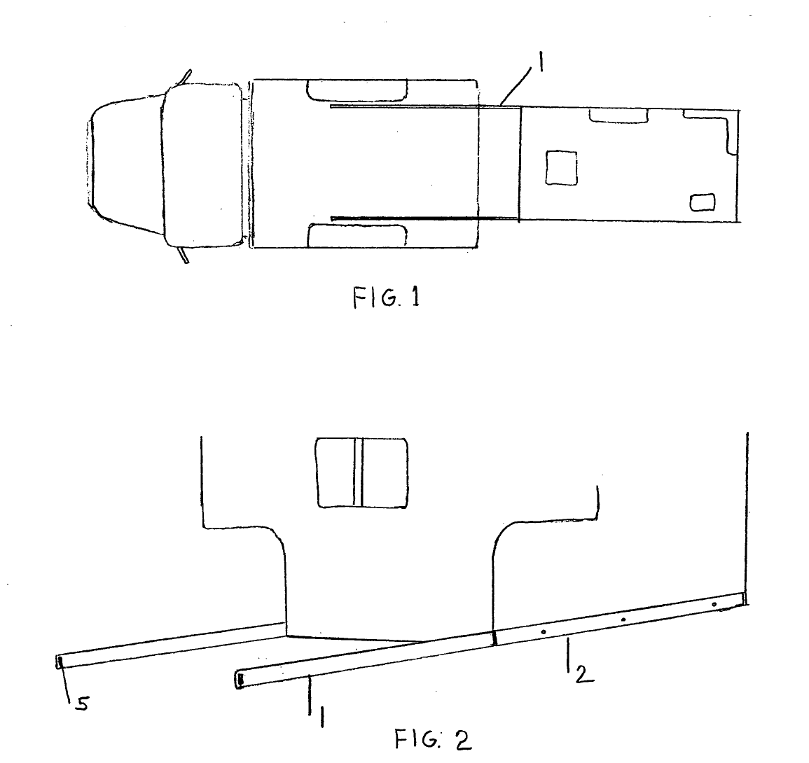

FIG. 1 illustrates the preferred embodiment of this invention, in which the driver of a pick-up truck has visually used the extended guide rails 1 to gain an alignment advantage and pre-position the pick-up truck in the correct height and angle necessary to facilitate and receive the camper into the limited space of the pickup truck bed. This view illustrates the communication of the guide rails 1 to a typical style pickup for proper alignment.

The guide rails 1 can serve in different alignment capacities and may communicate a somewhat different alignment path unique to different pickup truck beds or loading vehicles. The most notable alignment landmark common to most standard pickup trucks, and depicted in FIG. 1, is the wheel wells that rise from the pickup bed itself and that the camper box frame must fit between when the loading process is complete. FIG. 1 illustrates a pickup that has achieved proper alignment, using the guide rails 1, prior to the final loading process.

FIG. 1 further illustrates how the guide rails parallel the wheel wells giving the driver a preview of how the camper will be received into the pickup bed and thus facilitate the final loading process. As the driver proceeds backwards in the correct position the guide rails will contact the front vertical wall of the pickup bed and slide easily back into the case cavities where they remain until the next loading procedure.

FIG. 2 shows a multi-dimensional view of a camper with the guide rails 1 fully extended from within the cases 2 which in turn are fastened to the camper's lower edges. This view illustrates the case 2 running and defining the length of the camper so as to provide a cavity of a length necessary to house a functional length of guide rail. The length of the guide rails 1 and cases 2, as outlined in this patent, are constructed of lengths necessary to match and accommodate multiple length campers of both new and old construction

FIG. 3 is a side view of the invention with the guide rail 1 in the fully retracted position. This view shows the guide rail 1 being slightly longer than the case 2 and having a small portion of the guide rail 1 remaining outside the case cavity 2. The small remaining portion provides enough surface of the guide rail 1 to be gripped by a persons hand and then extended out for use. This view also shows identical holes 3 positioned along the length of the case 2 for fastening to previously built campers.

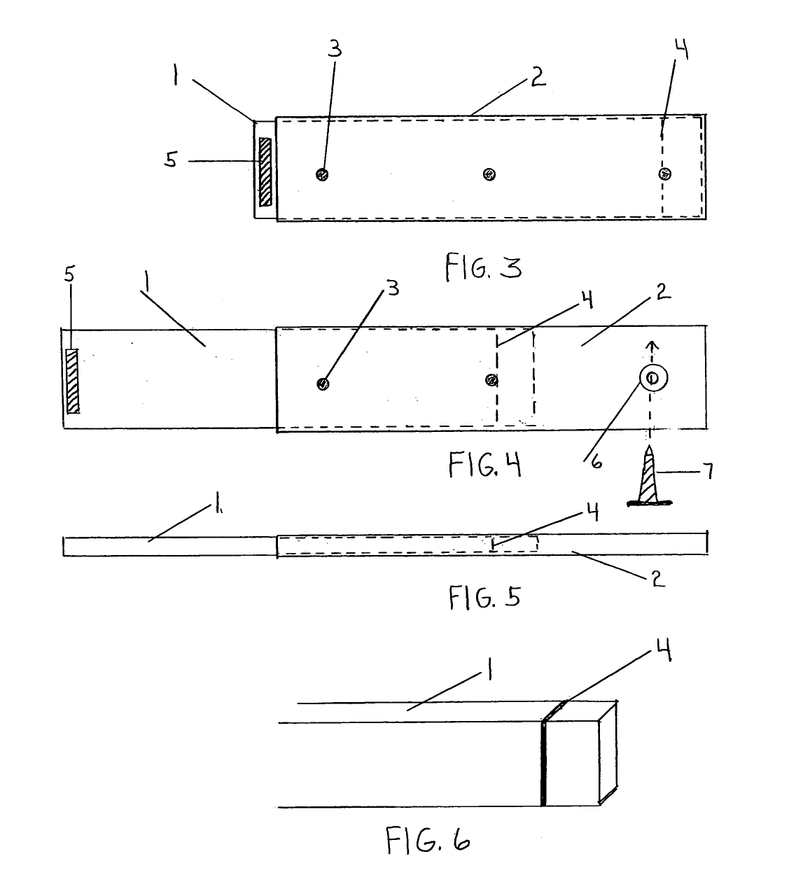

FIG. 4 shows the guide rail 1 partially extended from the case cavity 2 and shows a magnified view of a hole 6 provided for fastening to previously built campers. The surface of the case that will contact the camper when fastened (inside surface) having a smaller diameter hole than the outside surface of the case, and the outside surface having a hole large enough for the head of a fastener, such as a screw 7, to pass through. The inside surface having a smaller diameter hole will allow the fastener 7 to perform its function and tighten against the inner surface of the case and secure it to the camper. The fastener 7, having a flat head to secure the case in a flush manner so as to not interrupt the sliding motion of the guide rails through the case cavities. Though the cases 2, described in the present invention, are shown depicting a fastening method of conventional screws, it should be understood that the same lightweight cases and guide rail systems, as described in the present invention, are capable of being fastened to previously built campers by many different methods such as, but not limited to, adhesives or velcro type materials.

FIG. 3 and FIG. 4 illustrate the positioning of the grip tab 5 placed on the end of the guide rail 1. The grip tabs are placed on both sides of the end of the guide rails, right side and left side. The grip tabs help to facilitate the extraction of the rails from the case cavities. The grip tabs are fastened to the end of the guide rails by an adhesive or a pre-set adhesive manufactured on one side of a material that possesses traction properties. It should be understood that the function of a grip tab, as shown and described in this patent, can be offered in a variety of existing materials or substances that possess the characteristics intended to perform this function.

FIG. 5 is a top view of the invention placed on edge. This view depicts the guide rail 1 partially extracted from the case 2 and is provided to convey a preferred embodiment of this invention which is the thin structure of the two major components. The case and guide rail systems, of the present invention, are constructed of dimensions thin enough as to not interfere with the accommodations of the camper frame into the final loading destination.

FIG. 6 shows a multi-dimensional view of one end of a guide rail 1 and separate from a case. This view illustrates the stop line 4 on the opposite end of the grip tab end. The stop line is a bright or dark color and is provided to indicate the end of the extraction process. Both left and right side pickup camper loading guides are provided with stop lines to allow for equal extraction of each guide rail from the case cavities.

1. A right side and left side guide rail alignment device fastened to a pickup truck mounted camper, both sides functioning in the same capacity and both extends and retracts from within the thin case cavity fastened to the lower edges of the camper.

2. An alignment device, as recited in claim 1, for a pickup truck mounted camper, wherein said alignment guide rails are designed to pre-position a pickup truck or loading vehicle into proper alignment to further back up and load or transport a camper.

3. An alignment guide rail device residing in a similar case or cavity, built into a newly constructed camper, providing the same alignment and pre-positioning function, as recited in claim 2, and having the same extending and retracting capabilities.

4. An alignment device as recited in claim 1, wherein said guide rails are manually extracted, by a person, from within a case cavity attached to a previously built camper, or provided in a newly constructed pickup truck mounted camper.

5. An alignment device, as recited in claim 1, which is constructed of a smooth rigid material allowing a guide rail to fit snuggly, and travel smoothly, in and out of a case cavity.

6. An alignment device, as recited in claim 1, that is used as a visual alignment instrument by the driver of any loading, hauling, or transport vehicle.

7. An alignment device, as recited in claim 1, provided in multiple lengths and widths.

8. An alignment device, as recited in claim 1, constructed to be compatible and functional for all makes, models, and designs of pickup mounted campers.

9. An alignment device, as recited in claim 1, wherein said guide rails automatically retract during the loading process.
